(19) United States
(12) Patent Application Publication
(10) Pub. No.: US 2026/0339656 A1
(43) Pub. Date: Oct. 29, 2026

(54) CODE EXPLANATION LEVERAGING PROJECT MANAGEMENT ARTIFACTS

(71) Applicant: International Business Machines Corporation, Armonk, NY (US)

(72) Inventors: Karen Frida Yorav, Haifa (IL); Ziv Nevo, Yokneam Ilit (IL); ADI SOSNOVICH, Haifa (IL); ORNA RAZ, Haifa (IL); Marah Ghoummaid, Yafa an-Naseriyye (IL)

(21) Appl. No.: 19/192,805

(22) Filed: Apr. 29, 2025

(51) Int. Cl. G06F 8/73; G06F 40/40

(52) U.S. Cl. CPC G06F 8/73; G06F 40/40

(57) ABSTRACT

Providing an explanation for a code snippet includes receiving, a code snippet, the code snippet being maintained by a code management tool. A storage associated with the code management tool is scanned for artifacts associated with the code snippet. Context is built for the code snippet based at least on the artifacts. The code snippet and the context are fed into to a machine learning model trained to understand a natural language, the machine learning model generating a reason for the code snippet. An explanation including the reason for the code snippet is output.

### BACKGROUND

The present application relates generally to computers and computer applications, artificial intelligence agents, and more particularly to artificial intelligence agents providing code explanation, for example, in software engineering.

### BRIEF SUMMARY

The summary of the disclosure is given to aid understanding of a computer system and method of code explanation, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

In some embodiments, a computer-implemented method includes receiving, a code snippet, the code snippet being maintained by a code management tool. The computer-implemented method also includes scanning a storage associated with the code management tool for artifacts associated with the code snippet. The computer-implemented method also includes building context for the code snippet based at least on the artifacts. The computer-implemented method also includes feeding the code snippet and the context to a machine learning model trained to understand a natural language, the machine learning model generating a reason for the code snippet. The computer-implemented method also includes outputting an explanation including the reason for the code snippet.

In some embodiments, a computer program product comprising a set of one or more computer-readable storage media, and program instructions, collectively stored in the set of one or more storage media, for causing a processor set to perform computer operations that perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 shows an example of a computing environment, which can implement code explanation in some embodiments.

FIG. 2 is a system architecture illustrating an AI assistant implementation in some embodiments.

FIG. 3 is a flow diagram illustrating a method of an AI agent that provides explanations a code snippet or piece of code, in some embodiments.

FIG. 4 shows an example explanation provided by an AI agent in some embodiments.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code explanation algorithm 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

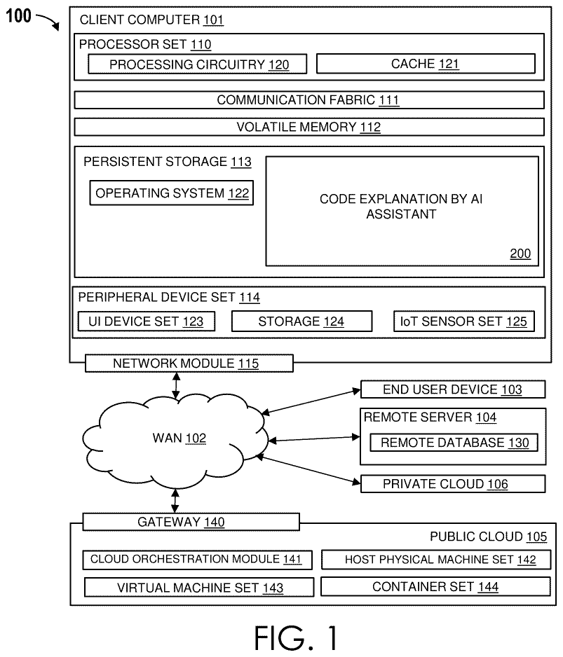

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Artificial intelligence (AI) assistants, also known as virtual or digital assistants, are computer or software applications that use artificial intelligence to understand and respond to user commands, assist users with one or more tasks. An AI agent can function as an AI assistant. AI assistants can respond through different types of communication modes such as through voice and/or text. AI assistants are designed to perform a variety of tasks, for example, managing calendars, setting reminders, providing information, controlling smart home devices, and/or other tasks. AI assistants can also be considered as chatbots that answer queries and provide detailed information in natural language and/or interact with a user in natural language exchange.

Code explanation is a use-case for AI assistants. In this use-case a user identifies a code snippet, and the AI assistant produces an explanation of how this code works. A code snippet includes lines of programming instructions, for example, written in a programming language. An example of a code can include software written in a programming language. Another example of a code can include a hardware design written in a hardware design language such as but not limited to Verilog or Very High Speed Integrated Circuit Hardware Description Language (VHDL). The explanation provides information with respect to the code execution, which is useful when trying to debug or modify the code. Generally the explanation answers the question of what the code does when executed. Existing AI assistants, however, do not answer why this needs to be done in the context of a particular application, the code snippet's requirements and features. In particular, given a code snippet (and the context of the libraries and components the code snippet depends on), code explanation may answer that this code snippet sorts events according to date. The explanation will give more or less the same answer regardless of a particular application's purpose, whether it is sorting security incidents or company social events.

In some embodiments, a system, method and/or technique disclosed herein can produce an explanation of why a particular piece of code is needed in the context of an application's architecture, features, requirements, user experience, and/or in other context. An AI assistant implementing the technique disclosed herein in some embodiments can save time in scenarios where developers need insight into the broader context of the code, beyond the execution. For example, the system, method and/or technique reduce the time invested by team members while on-boarding a new team member, or time spent recalling why a piece of code was added when getting back to old code. In addition, the system, method and/or technique speed up understanding of the significance of a code snippet by handling large amounts of information, utilizing multiple different sources, and providing an in-depth explanation.

The system, method and/or technique in some embodiments use the natural language text that exists in a code management tool, to provide to an AI agent in producing a software (SW) engineering explanation for a piece of code (different from or in addition to a code execution explanation). A code management tool refers to any combination of tools for version control, change management, project management, and task tracking. Such a code management tool maintains a storage such as an object store or another store that stores items such as commits, merge requests, work items, and/or other items used in the code management tool. Briefly, version control or change management refers to managing versions and changes, for instance, as the product is developed or updated by a team of developers. Project management tools help organize, prioritize, and link tasks in the project.

An example of a version control tool is Git. Git is a free, open source version control tool. An online platform (e.g., online tools and service) such as GitHub (from Microsoft Corporation, Redmond, Washington) incorporates version control features and hosts repositories so that users can create, store, change, merge and collaborate on files or code stored in the repositories. For instance, GitHub incorporates Git's version control features and hosts Git repositories so that they can be used collaboratively. GitHub as a tool maintains a store of commits, merge requests, discussion threads, and other work items. For example, the system, method and/or technique in some embodiments disclosed herein grounds an LLM (a component of the AI agent) with the natural language text of such commits, merge request, and discussion threads extracted from the storage such as the object store, to produce the explanation. The term “grounding” refers to adding text to the prompt given to an LLM, which is an internal component of the AI agent.

For an application that is developed with or via a code management tool, the system, method and/or technique finds natural language texts relevant to features, aspects and architecture in artifacts of the code management tool that are linked with the code snippet. Such artifacts can include, but are not limited to, commits, merge requests, discussion threads, problem reports, and/or other artifacts. For example, Git and GitHub provide artifacts such as issues, pull request descriptions, and commit messages. Briefly, in GitHub issues are a built-in feature used for tracking tasks, reporting bugs, requesting features, and facilitating discussions within a repository, for example, generally referred to herein as discussion threads; A pull request serves as a proposal to merge changes made in one branch of a repository into another, typically from a feature branch into the main branch. Pull requests facilitate code reviews, encourage collaboration, and maintain a clean, well-documented codebase; A commit logs or records (e.g., stores) changes to one or more files in a branch. A commit record includes the specific changes, and metadata such as when the changes were made, who created the changes, and/or others. For ease of explanation, the description herein refers to GitHub, however, the system, method and/or technique are applicable to any code management tools, e.g., one or more of version control, change management and/or project management tools.

In some embodiments, the system, method and/or technique can use application programming interfaces (APIs) to a code management tool to extract artifacts and follow links from one artifact to another, e.g., use GitHub APIs, to extract the history of commits for a particular line of code, follow links among commits, pull requests, and issues, and collect natural language text that is relevant to these lines of code. These texts may contain the reasons for adding and/or modifying the code. In some embodiments, the sources of information can extend beyond one code management tool, to other code management tools, and collateral documents such as specification documents, requirements documents, user manuals, and/or other documents having information about the code snippet.

In some embodiments, the system, method and/or technique answers a different question than a code execution question, for example, by explaining the code's purpose towards the application's features rather than, or in addition to, explaining what the code does when executed.

The system, method and/or technique can produce quality results independent of the programming language, support a use-case that code execution explanation does not support or does not support well enough. The system, method and/or technique leverage natural language texts that appear in code management artifacts such as GitHub artifacts.

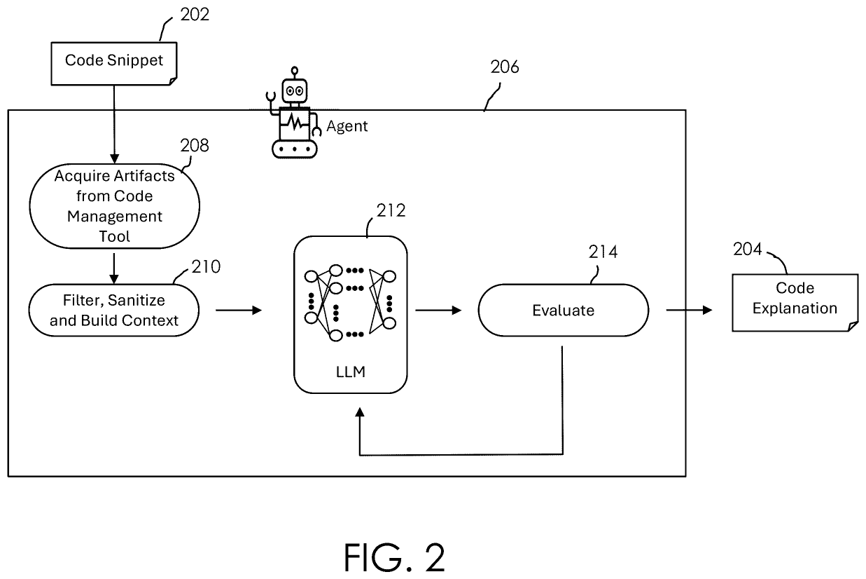

FIG. 2 is a system architecture illustrating an implementation of an AI agent that functions as an AI assistant providing code explanation for a given code snippet in some embodiments. In some embodiments, the AI agent's or AI assistant's input includes a program code, for example, a code snippet 202 or a pointer to a code snippet, or function, within a repository of a code management tool, such as GitHub repository. For example, a code snippet 202 includes programming instructions. The repository of the code management tool includes the code snippet 202, as well as other code pieces that make up an application. The AI assistant's output is an explanation of the purpose this input code snippet serves within the context of the application, for example, shown at 204. The system, method and/or technique leverage access to code management tool APIs, such as GitHub APIs, and any collateral documents relating to the application that can be supplied.

In some embodiments, an implementation of an AI agent 206 may incorporate architecture that includes a Retrieval-Augmented Generation (RAG) architecture. For example, in some embodiments, the implementation uses a database such as a vector database to store artifacts extracted from a repository of a code management tool such as GitHub, including but not limited to, pull requests, issues, commits, and other types of metadata. For instance, during a setup phase the implementation includes scanning a repository of a code management tool, extracting relevant artifacts, and processing those artifacts into a database such as a vector database (DB). For example, as shown at 208, the AI agent 206 acquires artifacts from a storage such as an object store or another store associated with the code management tool and processes those artifacts. The storage such as an object store or another store stores artifacts associated with codes or code snippets (pieces of code) stored in the repository of the code management tool. The artifacts include, but are not limited to, thread discussions about the code snippet (e.g., issues), commits (code changes) and/or merge or pull requests.

In some embodiments, an implementation of the AI agent 206 can include invoking APIs of a code management tool, such as GitHub APIs, on each code execution to collect relevant artifacts and build the context.

In some embodiments, an implementation of the AI agent 206 may retrieve one or more of the following sources of information. For example, the implementation retrieves collateral documents related to the application such as feature lists, specification documents, design documents, discussion threads (e.g., GitHub Discussions), user manual, meeting minutes, readme files. Other types or additional sources of information can be accessed for information.

At 210, the implementation of the AI agent 206 includes processing the data or information retrieved at 208. For instance, the implementation includes filtering, sanitizing and building context. Examples of filtering include, but are not limited to, dropping items that that are immaterial because they only change documentation, make style improvements, or fix syntax errors. Examples of sanitizing include, but are not limited to, eliminating malicious text that is part of a security attack on the LLM, eliminating sensitive information, and shortening the text by eliminating template verbiage and other information determined to be immaterial. The context is a part of the prompt that is fed into the LLM. The prompt contains general instructions, specific task instructions, and context information. For example, the general instructions are to write an explanation, the specific task is the code snippet in question, and the context includes other relevant code snippets and relevant texts from code management tool artifacts. In some embodiments, in building the context, the AI agent adjusts the explanation to the persona and the use-case. For instance, the AI agent may determine the type of information in the artifacts and the type of instructions to input to the LLM based on a specific user of the AI agent. For example, a developer who needs to modify the code snippet (bug fix, adding a feature, modernize) may need: the existing requirements which this code snippet relates to, historical changes and what other code segment the code snippet potentially affects. As another example, a security officer reviewing the code may need: a reason for any calls to risky APIs, a reason for network connections opened, and/or other types of explanation.

Processing of documents from the sources of information may leverage metadata to correlate the information from the documents to the code. For example, logged meeting minutes may have time associated with the meeting minutes, the time being considered as metadata. In this example, the processing may retrieve and correlate meeting minutes from meetings that occurred around the date that a fix (correction) was committed to the code management tool.

An AI agent or AI assistant uses a large language model (LLM) 212. Large language models (LLMs) are a category of foundation models trained on vast amounts of data making them capable of understanding and generating natural language and other types of content to perform a wide range of tasks. An LLM uses deep learning to understand how words, sentences, and characters work together, and can perform tasks like translation, summarization, and question answering.

To minimize factually incorrect answers in the AI agent's responses, the implementation may ground a large language model (LLM) with commits from the history for the code snippet, the merge requests in which these commits were introduced, and all work items linked to any of these commits and merge requests. For instance, information from those artifacts is added to the prompt that is fed into the LLM. The implementation may also build a database such as a vector database with natural language texts extracted from all sources of information and ground the LLM based on semantic similarity. The implementation may further ground the LLM with project management artifacts such as GitHub artifacts associated with functions that appear in the call graph of the code snippet (or function) in question. The implementation may also ground the LLM with a description of the application architecture, which is extracted from the repository by a static analysis logic. Here, application architecture refers to the list of components (packages, modules and/or micro-services) that make up the application and the relationships between them (dependencies, calls-to and/or called-by, hypertext transfer protocol (http) requests, and/or others). The implementation may also ground the LLM with the output of an existing code explanation agent that supplies a description of the code execution. The implementation may also ground the LLM with description comments from the code, in particular component headers and function descriptions.

LLM 212 takes as input a prompt that includes instructions, the code snippet, some of the acquired artifacts, and the context built at 210, and produces a response. For instance, LLM 212 is given a prompt that includes the code snippet and the context, and a request or prompt to explain the code snippet. The LLM 212's response (explanation) may be evaluated at 214. Generally, an evaluation (also referred to as “validation”) is a process where the output of the LLM is examined to determine whether it is “good” enough to present to the user. LLM 212 may be run multiple times based on the evaluation performed at 214. If the LLM 212's response is satisfactory, for example, based on meeting a predefined threshold or convergence, the AI agent 206 provides an output 204, which is an explanation or reasons regarding the code snippet.

A storage such as an object store associated with a code management tool usually includes a wealth of natural language texts such as thread discussions, pull requests, and commits messages, and/or other natural language text data regarding a piece of code (code snippet) stored in a repository, documenting reasons and history for adding or modifying that code. The system, method and/or technique leverages natural language texts that exist in such code management tool to ground an AI agent in producing a high-level explanation for a piece of code. The approach provided herein is always able to supply references for its explanation, need not be aware of, or dependent, on specific programming language of the code, for which the AI agent is providing the explanation, has a low probability of producing factually incorrect explanation, and is also able to notify the user that there are no explanations for a particular piece of code.

The AI agent is able to provide a summary of the history of the code, e.g., starting from when the code is added to the repository and listing a history of modifications made to the code. In some embodiments, the AI agent supplements the information as to what the code does, with why the code is doing what it is doing, e.g., what it is needed for, which features or aspect it is part of. In some embodiments, the AI agent can be used to enhance code that is lacking comments, and supply grounding for other software engineering AI agents that handle tasks such as question and answering, test generation, documentation, and/or debug build failures. In some embodiments, the AI agent uses project management artifacts, e.g., the body of pull request, issues and/or commits to ground an LLM for high level code explanation.

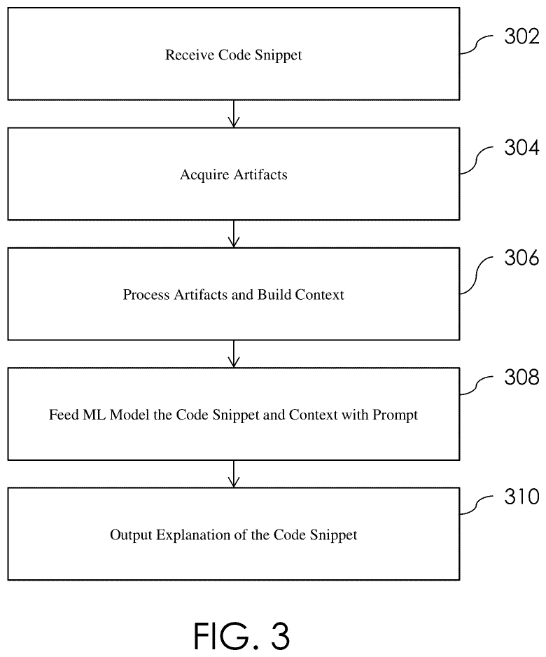

FIG. 3 is a flow diagram illustrating a method of an AI agent that provides explanations for a code snippet or piece of code, in some embodiments. The method can be performed on or by one or more computer or hardware processors, operating in a computing environment shown in FIG. 1 by way of example. At 302, a code snippet is received, for example, by a processor running the method. The code snippet includes lines of programming instructions, e.g., in a programming language, which can be compiled by a compiler or interpreted for execution on a computer processor. A code management tool maintains the code snippet, storing the code snippet, among others, in a repository associated with the code management tool.

At 304, the processor retrieves or acquires artifacts associated with the code snippet by scanning or searching a storage such as an object store or another store associated with the code management tool for artifacts associated with the code snippet. For instance, the storage such as an object store or another store associated with the code management tool may also store various metadata, and information related to the code snippet. Such information may include discussion threads in natural language text regarding the code snippet, various actions such as commits and merge requests.

At 306, the processor processes the artifacts and builds context about the code snippet based at least on the artifacts. Other code snippets in the repository can be used to build the context.

At 308, the processor feeds the code snippet and the context as input to a machine learning (ML) model with a prompt to explain the code snippet in consideration with the context. The machine learning model can be a foundation model or a large language model, trained with vast amounts of data to understand the natural language and generate responses to user queries. Based on the code snippet and the context, the machine language model outputs an explanation of the code snippet that includes a reasons for the code snippet, for example, why the code snippet is doing what it is doing. As described above, the machine language model can be a foundation model, e.g., a large language model, which may be based on a transformer architecture, and include multiple layers of neural networks.

At 310, the processor provides an explanation with reasons for the code output by the machine learning model, as explanation for the code snippet.

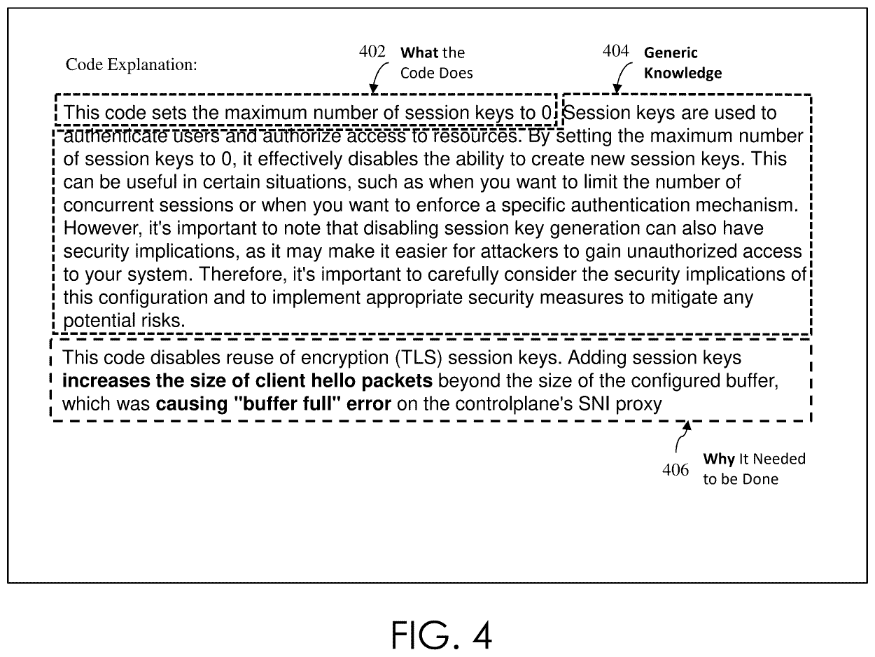

FIG. 4 shows an example explanation provided by an AI agent in some embodiments. A user interface may present or display what the code does 402, a generic knowledge 404, and a reason 406, for example, why the code is doing what it does. For instance, the AI agent interacts with the user and outputs a visualization that provide reasons for the code.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof. As used herein, the phrase “in some embodiments” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
receiving, a code snippet, the code snippet being maintained by a code management tool;
scanning a storage associated with the code management tool for artifacts associated with the code snippet;
building context for the code snippet based at least on the artifacts;
feeding the code snippet and the context to a machine learning model trained to understand a natural language, the machine learning model generating a reason for the code snippet; and
outputting an explanation including the reason for the code snippet.

2. The computer-implemented method of claim 1, wherein the artifacts include at least discussion threads associated with the code snippet.

3. The computer-implemented method of claim 1, wherein the artifacts include at least commit records associated with the code snippet.

4. The computer-implemented method of claim 1, wherein the artifacts include at least merge requests associated with the code snippet.

5. The computer-implemented method of claim 1, wherein the artifacts are further retrieved from additional documents external to the code management's store.

6. The computer-implemented method of claim 1, wherein the machine learning model is a foundation model.

7. The computer-implemented method of claim 1, wherein the machine learning model is grounded with commits from a history for the code snippet, merge requests in which the commits were introduced, and discussion threads linked to the commits and the merge requests.

8. The computer-implemented method of claim 1, wherein the artifacts are processed by building a database with natural language texts of the artifacts.

9. A computer program product comprising:
one or more computer-readable storage media; and
program instructions stored on the one or more storage media to perform operations comprising:
receiving, a code snippet, the code snippet being maintained by a code management tool;
scanning a storage associated with the code management tool for artifacts associated with the code snippet;
building context for the code snippet based at least on the artifacts;
feeding the code snippet and the context to a machine learning model trained to understand a natural language, the machine learning model generating a reason for the code snippet; and
outputting an explanation including the reason for the code snippet.

10. The computer program product of claim 9, wherein the artifacts include at least discussion threads associated with the code snippet.

11. The computer program product of claim 9, wherein the artifacts include at least commit records associated with the code snippet.

12. The computer program product of claim 9, wherein the artifacts include at least merge requests associated with the code snippet.

13. The computer program product of claim 9, wherein the artifacts are further retrieved from additional documents external to the storage.

14. The computer program product of claim 9, wherein the machine learning model is a foundation model.

15. The computer program product of claim 9, wherein the machine learning model is grounded with commits from a history for the code snippet, merge requests in which the commits were introduced, and discussion threads linked to the commits and the merge requests.

16. A computer system comprising:
a processor set;
a set of one or more computer-readable storage media;
program instructions, collectively stored in the set of one or more computer-readable storage media, for causing the processor set to perform the following computer operations:
receiving, a code snippet, the code snippet being maintained by a code management tool;
scanning a storage associated with the code management tool for artifacts associated with the code snippet;
building context for the code snippet based at least on the artifacts;
feeding the code snippet and the context to a machine learning model trained to understand a natural language, the machine learning model generating a reason for the code snippet; and
outputting an explanation including the reason for the code snippet.

17. The system of claim 16, wherein the artifacts include at least discussion threads associated with the code snippet.

18. The system of claim 16, wherein the artifacts include at least commit records associated with the code snippet.

19. The system of claim 16, wherein the artifacts include at least merge requests associated with the code snippet.

20. The system of claim 16, wherein the artifacts are further retrieved from additional documents external to the storage.
